(19) United States
(12) Patent Application Publication
(10) Pub. No.: US 2025/0249808 A1
(43) Pub. Date: Aug. 7, 2025

(54) METHODS, SYSTEMS, AND DEVICES FOR COOLING A SEAT OF A VEHICLE

(71) Applicant: Toyota Motor Engineering & Manufacturing North America, Inc., Plano, TX (US)

(72) Inventors: John D. Harkleroad, Ypsilanti, MI (US); Vasudeva S. Murthy, Ann Arbor, MI (US); William P. Dix, Highland Park, MI (US); David Cosgrove, Milford, MI (US)

(73) Assignees: Toyota Motor Engineering & Manufacturing North America, Inc., Plano, TX (US); Toyota Jidosha Kabushiki Kaisha, Toyota-shi, Aichi-ken (JP)

(21) Appl. No.: 18/433,180

(22) Filed: Feb. 5, 2024

(51) Int. Cl. B60N 2/56; B60H 1/00

(52) U.S. Cl. CPC B60N 2/5642; B60H 1/00828; B60N 2/5628

(57) ABSTRACT

Methods, systems, and devices for a seat cooling system. The seat cooling system includes a fan configured to pull air through a seat in an inward flow direction and to push air through the seat in an outward flow direction and an electronic control unit (ECU) connected to the fan. The ECU is configured to control an HVAC device to direct conditioned air into a cabin of a vehicle. The ECU can be further configured to control the fan to pull at least a portion of the conditioned air through the seat in the inward flow direction when an internal temperature of the vehicle is greater than a first temperature threshold and control the fan to push at least a portion of the conditioned air through the seat in the outward flow direction when the internal temperature of the vehicle is less than a second temperature threshold.

### BACKGROUND

### Field

The present disclosure relates to a system, method, and/or device for cooling a seat of a vehicle.

### Description of the Related Art

As temperatures vary, vehicle interiors can become uncomfortable, for example too hot or too cold, depending on user preference or tolerance. Some vehicles include seat ventilation systems for seat temperature control. For example, a seat within a vehicle can include a ventilation system for ventilating a seat surface (e.g., in warm weather). Vehicle seat ventilation systems typically move air in a single direction through a perforated seat surface.

Conventional vehicle seat ventilation systems do not use an HVAC device to condition (i.e., cool) the air being pushed on the seat occupant and do not consider the thermal mass and thermal energy of the seat, and thus may push hot air onto the seat occupant because of the seat heating up the air leading to occupant discomfort. Further, by not considering the thermal mass and thermal energy of the seat, these conventional vehicle seat ventilation systems do not operate in an efficient manner and result in increased power consumption, leading to decreased fuel and/or energy efficiency.

Accordingly, it is desirable to provide systems, methods, and devices for quickly and efficiently conditioning a seat of a vehicle.

### SUMMARY

In general, one aspect of the subject matter described in this disclosure may be embodied in a seat cooling system for a vehicle. The seat cooling system may include an HVAC device configured to direct conditioned air into a cabin of the vehicle. The seat cooling system may further include a seat coupled to a floor of the vehicle. The seat having a seating surface that is perforated such that air can flow through the seating surface, and a base below the seating surface. The seat cooling system may further include a fan coupled to the base. The fan may be configured to pull air through the seating surface in an inward flow direction and to push air through the seating surface in an outward flow direction. The seat cooling system may further include a temperature sensor configured to detect an internal temperature of the vehicle. The seat cooling system may further include an electronic control unit (ECU) electrically connected to the HVAC device, the fan, and the temperature sensor. The ECU may be configured to control the HVAC device to direct a first flow of conditioned air and a second flow of conditioned air into the cabin of the vehicle. The ECU may be further configured to control the fan to pull at least a portion of the first flow (e.g., an inward flow) of conditioned air through the seating surface in the inward flow direction when the internal temperature of the vehicle is greater than a first temperature threshold. The ECU may be further configured to reverse the fan to push at least a portion of the second flow (e.g., an outward flow) of conditioned air through the seating surface in the outward flow direction when the internal temperature of the vehicle is less than a second temperature threshold.

In another aspect, the subject matter may be embodied in a seat cooling system for a vehicle. The seat cooling system may include an HVAC device configured to direct conditioned air into a cabin of the vehicle. The seat cooling system may further include a seat coupled to a floor of the vehicle. The seat having a seating surface that is perforated such that air can flow through the seating surface, and a base below the seating surface. The seat cooling system may further include a fan coupled to the base. The fan may be configured to pull air through the seating surface in an inward flow direction and to push air through the seating surface in an outward flow direction. The seat cooling system may further include a temperature sensor configured to detect an internal temperature of the vehicle. The seat cooling system may further include an electronic control unit (ECU) electrically connected to the HVAC device, the fan, and the temperature sensor. The ECU may be configured to control the HVAC device to direct a first flow of conditioned air through a front air vent of the vehicle and toward the seat and a second flow of conditioned air through a rear air vent of the vehicle and toward a bottom of the seat. The ECU may be further configured to control the fan to pull at least a portion of the first flow of conditioned air through the seating surface in the inward flow direction when the internal temperature of the vehicle is greater than a first temperature threshold. The ECU may be further configured to reverse the fan to push at least a portion of the second flow of conditioned air through the seating surface in the outward flow direction when the internal temperature of the vehicle is less than a second temperature threshold.

In another aspect, the subject matter may be embodied in a seat cooling system for a vehicle. The seat cooling system may include an HVAC device configured to direct conditioned air into a cabin of the vehicle. The seat cooling system may further include a plurality of seats coupled to a floor of the vehicle. Each seat of the plurality of seats may have a seating surface that is perforated such that air can flow through the seating surface, and a base below the seating surface. The seat cooling system may further include one or more fans coupled to the base of each seat of the plurality of seats. The one or more fans may be positioned under each seat and configured to pull air through the seating surface of each seat of the plurality of seats in an inward flow direction and to push air through the seating surface of each seat of the plurality of seats in an outward flow direction. The seat cooling system may further include one or more temperature sensors configured to detect an internal temperature of the vehicle. The one or more temperature sensors may be located above the seat and may be coupled to the dashboard or coupled to the steering wheel. The seat cooling system may further include an electronic control unit (ECU) electrically connected to the HVAC device, the one or more fans, and the one or more temperature sensors. The ECU may be configured to control the HVAC device to direct one or more first flows of conditioned air through one or more front air vents of the vehicle and toward a quantity of seats of the plurality of seats and one or more second flows of conditioned air through one or more rear air vents of the vehicle and toward a bottom of the quantity of seats of the plurality of seats. The ECU may be further configured to control the one or more fans to pull at least a portion of the one or more first flows of conditioned air through the seating surface of the quantity of seats of the plurality of seats in the inward flow direction when the internal temperature of the vehicle is greater than a first temperature threshold. The ECU may be further configured to reverse the one or more fans to push at least a portion of the one or more second flows of conditioned air through the seating surface of the quantity of seats of the plurality of seats in the outward flow direction when the internal temperature of the vehicle is less than a second temperature threshold.

### BRIEF DESCRIPTION OF THE DRAWINGS

Other systems, methods, features, and advantages of the present disclosure will be apparent to one skilled in the art upon examination of the following figures and detailed description. Component parts shown in the drawings are not necessarily to scale and may be exaggerated to better illustrate the important features of the present disclosure. In the drawings, like reference numerals designate like parts throughout the different views.

FIG. 1 is a block diagram of an example seat cooling system for a vehicle according to an aspect of the disclosure.

FIG. 2 is a schematic side view of a cabin of a vehicle including the example seat cooling system of FIG. 1 according to an aspect of the disclosure.

FIG. 3 is a schematic side view of a cabin of a vehicle including the example seat cooling system of FIG. 1 according to an aspect of the disclosure.

FIG. 4 is a schematic side view of a cabin of a vehicle including the example seat cooling system of FIG. 1 and illustrates one or more air ducts according to an aspect of the disclosure.

FIG. 5 is a schematic side view of a cabin of a vehicle including the example seat cooling system of FIG. 1, with the vehicle being a plane according to an aspect of the disclosure.

FIG. 6 is a schematic sectional view of a portion of the example seat cooling system of FIG. 1 and illustrates a fan pulling air in an inward flow direction according to an aspect of the disclosure.

FIG. 7 is a schematic sectional view of a portion of the example seat cooling system of FIG. 1 and illustrates a fan pushing air in an outward flow direction according to an aspect of the disclosure.

FIG. 8 is a flow diagram of an example process for controlling the seat cooling system of FIG. 1 according to an aspect of the disclosure.

FIG. 9 is a flow diagram of an example process for controlling the seat cooling system of FIG. 1 according to an aspect of the disclosure.

### DETAILED DESCRIPTION

Disclosed herein are systems, methods, devices, and/or vehicles for implementing a seat cooling system. The seat cooling system controls a direction of airflow through a seat of a vehicle from an inward flow direction to an outward flow direction to increase the speed at which the seat is cooled, to increase occupant (i.e., a person who is a passenger, driver, and/or owner of the vehicle) comfort, and to increase fuel and/or energy efficiency of the vehicle. Particular embodiments of the subject matter described in this disclosure may be implemented to realize one or more of the following advantages.

The seat cooling system provides seat and/or seat occupant cooling in the quickest and most efficient manner possible by taking into account a thermal mass of the seat and an amount of thermal energy within the seat, thereby improving fuel economy, expanding EV, PHEV, HV, and/or FC vehicle range, and increasing seat occupant comfort. Seats within vehicles (e.g., automobiles and/or planes), may have a high thermal mass due to being made of dense materials. A high thermal mass generally corresponds to a high amount of thermal energy being contained within the seat when, for example, an ambient temperature outside the vehicle is high and/or the seat is in direct sunlight. The combination of high thermal mass and high amount of thermal energy means that air pushed through the seat will heat up and thus hot air would be blown onto the seat occupant. However, the seat cooling system addresses this issue by first pulling conditioned (i.e., cooled and/or cold) air through the seat in an inward flow direction (i.e., conditioned air is pulled from above and/or in front of the seat, through the seat, and toward the bottom of the seat) until the seat has sufficiently cooled, and then pushing conditioned air in an outward flow direction (i.e., conditioned air is pushed from below and/or behind the seat, through the seat, and toward the seat occupant).

Moreover, the seat cooling system is able to monitor and/or receive sensor outputs to determine when to change from the inward flow direction to the outward flow direction thereby maximizing seat occupant comfort and fuel and/or energy efficiency. In one aspect, the inward flow is performed for a set period of time (e.g., 10-30 seconds) before the outward flow is performed.

Moreover, the seat cooling system has the benefit of providing direct cooling to the occupant by conditioning the air being blown onto the occupant through the seat. The seat cooling system may use sensors to determine whether an occupant is sitting in a particular seat of the vehicle and may condition the seat if an occupant is detected, and may direct all of the conditioned air to the detected occupant such that energy is not wasted on cooling areas and/or seats of the vehicle where no occupant is sitting. Thus, the seat cooling system may cool the occupant more efficiently and faster than conventional systems and reduce the need for additional cooling from a conventional HVAC system of the vehicle. This not only improves fuel economy and energy efficiency by reducing compressor and/or electrical load but may also improve packaging and safety by reducing the size of a heat exchanger of the vehicle.

Moreover, the seat cooling system has the benefit of preconditioning the seat and/or a cabin of the vehicle manually through a user interface of the vehicle and/or automatically through analysis of the occupant's behavior and/or weather conditions. The preconditioning of the seat and/or the cabin of the vehicle may occur for a predetermined amount of time, for example, 1-2 minutes, prior to the occupant entering the cabin of the vehicle and/or after the occupant has been seated on the seat of the vehicle.

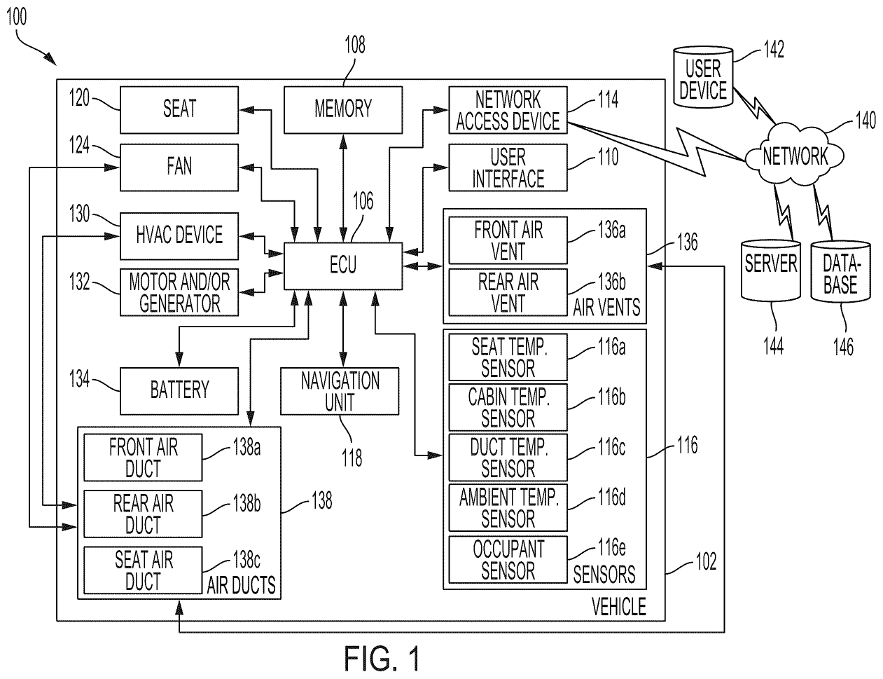

FIG. 1 is a block diagram for an example seat cooling system 100 (also can be referred to as a seat ventilation system 100). The seat cooling system 100 or a portion thereof may be retro-fitted, coupled to, include or be included within a vehicle 102 or separate from the vehicle 102. The vehicle 102 may be a conveyance capable of transporting a person, an object, or a permanently or temporarily affixed apparatus. The vehicle 102 may be a self-propelled wheeled conveyance, such as a car, a sports utility vehicle, a truck, a bus, a van or other motor, battery or fuel cell driven vehicle. For example, the vehicle 102 may be an electric vehicle, a hybrid vehicle, a hydrogen fuel cell vehicle, a plug-in hybrid vehicle or any other type of vehicle that has a fuel cell stack, a motor, an engine, and/or a generator. Other examples of vehicles include bicycles, trains, planes, or boats, and any other form of conveyance that is capable of transportation. The vehicle 102 may be semi-autonomous or autonomous. That is, the vehicle 102 may be self-maneuvering and navigate without human input. An autonomous vehicle may have and use one or more sensors and/or a navigation unit to drive autonomously.

The seat cooling system 100 and/or the vehicle 102 may include a motor and/or generator 132. The motor and/or generator 132 may be located within an engine bay of the vehicle 102. The motor and/or generator 132 may be an internal combustion engine (ICE). In this regard, the motor and/or generator 132 may combust an air and fuel mixture to provide power to the vehicle 102 and/or components of the vehicle 102 and/or the seat cooling system 100. Accordingly, the motor and/or generator 132 can cause the vehicle 102 to accelerate, decelerate, or maintain a desired velocity. It should be understood that the motor and/or generator 132 may include combinations of an ICE and an electric motor, such as for hybrid vehicle applications for example. In examples, the motor and/or generator 132 may be an electric motor. In this regard, the motor and/or generator 132 may be an electric motor and an electric generator that converts electrical energy into mechanical power, such as torque, and converts mechanical power into electrical energy. The motor and/or generator 132 may be electrically connected to a battery 134. The motor and/or generator 132 may convert energy from the battery 134 into mechanical power, and may provide energy back to the battery 134, for example, via regenerative braking. The battery 134 may be electrically connected to the motor and/or generator 132 and may provide electrical energy to and/or receive electrical energy from the motor and/or generator 132. The battery 134 may provide electrical energy to the seat cooling system 100.

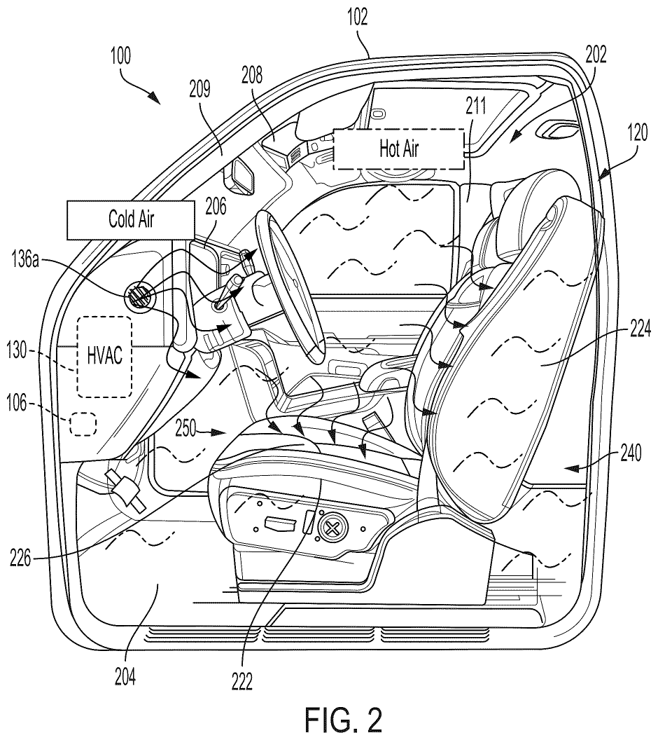

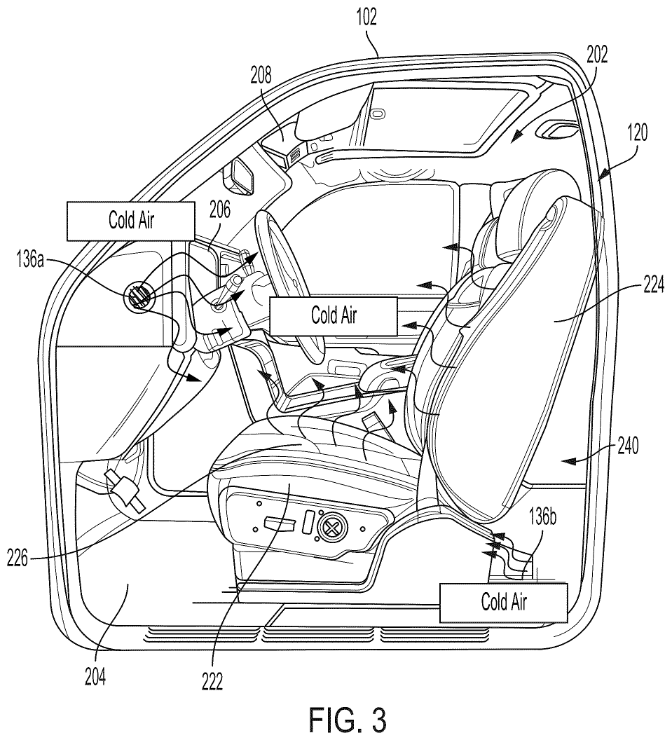

FIGS. 2 and 3 are schematic side views of a cabin 202 of the vehicle 102 including the example seat cooling system 100 of FIG. 1. With combined reference to FIGS. 1-3, the seat cooling system 100 may further include a heating, ventilation, and air conditioning (HVAC) device 130. The HVAC device 130 may be located within the engine bay of the vehicle 102 and/or at least partially within a dashboard (or instrument panel) 206 of the vehicle 102. The HVAC device 130 may be adapted for operation in an electric, gas, and/or hybrid automobile. In examples, the HVAC device 130 may be adapted for operation in a plane (e.g., a prop aircraft, a turboprop aircraft, a jet aircraft, etc.). The HVAC device 130 may include a heat pump, a separator, a compressor, a condenser, an expansion valve, a receiver (or dryer), and/or an evaporator. The HVAC device 130 may receive air from within and/or outside the cabin 202 and may direct conditioned air into the cabin 202. In examples, the HVAC device 130 may provide conditioned air to one or more air ducts 138 within the vehicle 102, and the conditioned air may flow within the one or more air ducts 138 and then out of one or more air vents 136 and into the cabin 202. In examples, the HVAC device 130 may also provide cooling to the battery 134 and/or electronics of the vehicle 102.

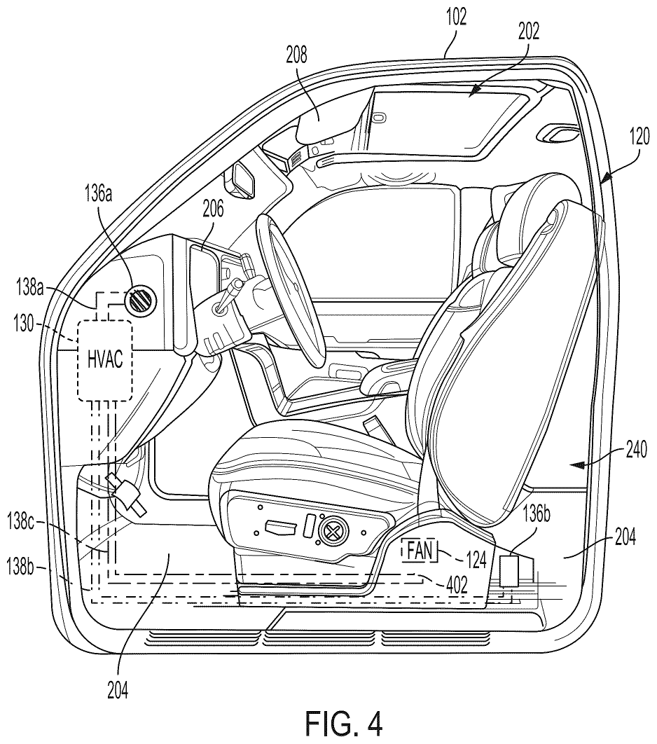

FIG. 4 is a schematic side view of the cabin 202 of the vehicle 102 including the example seat cooling system 100 of FIG. 1, with various components of the cabin 202 not pictured to aid in illustrating certain features of the seat cooling system 100, in examples. With combined reference to FIGS. 1-4, the seat cooling system 100 may further include the one or more air ducts 138. The one or more air ducts 138 may receive and/or carry air and/or conditioned air to and/or from various locations and/or components of the vehicle 102 and/or the seat cooling system 100. Each of the one or more air ducts 138 may, independently, close and prevent conditioned air from exiting the respective air duct of the one or more air ducts 138. The one or more air ducts 138 may include a front air duct 138a, a rear air duct 138b, and/or a seat (or dedicated) air duct 138c. In examples, the seat cooling system 100 may include a plurality of front air ducts, a plurality of rear air ducts, and/or a plurality of seat air ducts. The front air duct 138a may be coupled to the HVAC device 130 and may be located within a floor 204 of the vehicle 102, the dashboard 206, and/or a ceiling 208 of the vehicle 102 and may carry conditioned air from the HVAC device 130 to an area of the floor 204, the dashboard 206, the ceiling 208, and/or the cabin 202. The rear air duct 138b may be coupled to the HVAC device 130 and may be located within the floor 204 and/or the ceiling 208 and may carry conditioned air from the HVAC device 130 to an area of the floor 204, the ceiling 208, and/or the cabin 202. The seat air duct 138c may be coupled to the HVAC device 130 and located within the floor 204 and/or a seat 120 and may carry conditioned air from the HVAC device 130 to an area of the floor 204 and/or the seat 120 and/or may carry hot air from the seat 120 to outside the cabin 202 and/or may carry the hot and/or conditioned air back to the HVAC device 130.

The seat cooling system 100 may further include the one or more air vents 136. The one or more air vents 136 may be positioned within the cabin 202. Each of the one or more air vents 136 may include slats and/or flaps to control a direction and/or amount of airflow through the respective air vent of the one or more air vents 136. In examples, the slats and/or flaps of the one or more air vents 136 may be manipulated by an occupant to change the direction and/or amount of airflow. The one or more air vents 136 may close to prevent conditioned air from exiting the one or more air vents 136. The one or more air vents 136 may include one or more front air vents 136a and/or one or more rear air vents 136b (as shown more clearly in FIGS. 3 and 4).

The one or more front air vents 136a may be positioned above, in front, and/or forward of the seat 120. In examples, the one or more front air vents 136a may be coupled to one or more A pillars 209, one or more B pillars 211, one or more C pillars (not shown), the dashboard 206, the ceiling 208, and/or to one or more doors of the vehicle 102. The one or more front air vents 136a may receive conditioned air from the front air duct 138a and may facilitate directing the conditioned air into the cabin 202. In examples, the one or more front air vents 136a may facilitate directing the conditioned air into the cabin 202 and toward the seat 120, a lower seating surface 226 of the seat 120, and/or an upper seating surface 228 of the seat 120.

The one or more rear air vents 136b may be positioned below, behind, and/or rearward of the seat 120. In examples, the one or more rear air vents 136b may be coupled to the floor 204 of the vehicle 102. The one or more rear air vents 136b may receive conditioned air from the rear air duct 138b and/or the seat air duct 138c and may facilitate directing the conditioned air into the cabin 202. In some examples, the one or more rear air vents 136b may facilitate directing the conditioned air into the cabin 202 and toward a back 240 and/or bottom of the seat 120, the lower seating surface 226, and/or the upper seating surface 228.

The seat cooling system 100 may further include the seat 120. The seat 120 may be coupled to the floor 204 and/or located within the cabin 202. The seat 120 may receive and/or secure the occupant. As shown in FIGS. 2 and 3, the seat 120 may be a driver's seat. However, in examples, the seat 120 may be any other seat within the vehicle 102. In examples, the seat cooling system 100 may include a plurality of seats, with at least one and/or all of the seats of the plurality of seats being capable of being cooled by the seat cooling system 100.

The seat 120 may include an upper seat half 224 for supporting the occupant's back and a lower seat half 222 for supporting the occupant's legs. The lower seat half 222 may include the lower seating surface 226. The upper seat half 224 may include the upper seating surface 228. The seating surfaces 226, 228 may each have an outer surface facing the occupant when the occupant is seated in the seat 120 and an inner surface facing away from the occupant when the occupant is seated in the seat 120. The seating surfaces 226, 228 may each be perforated such that air can flow through the seating surfaces 226, 228. In examples, only a portion of each of the seating surfaces 226, 228 may be perforated. The seating surfaces 226, 228 may be made of synthetic (e.g., nylon, vinyl, polyester, etc.) and/or natural materials (e.g., leather, wool, cotton, etc.).

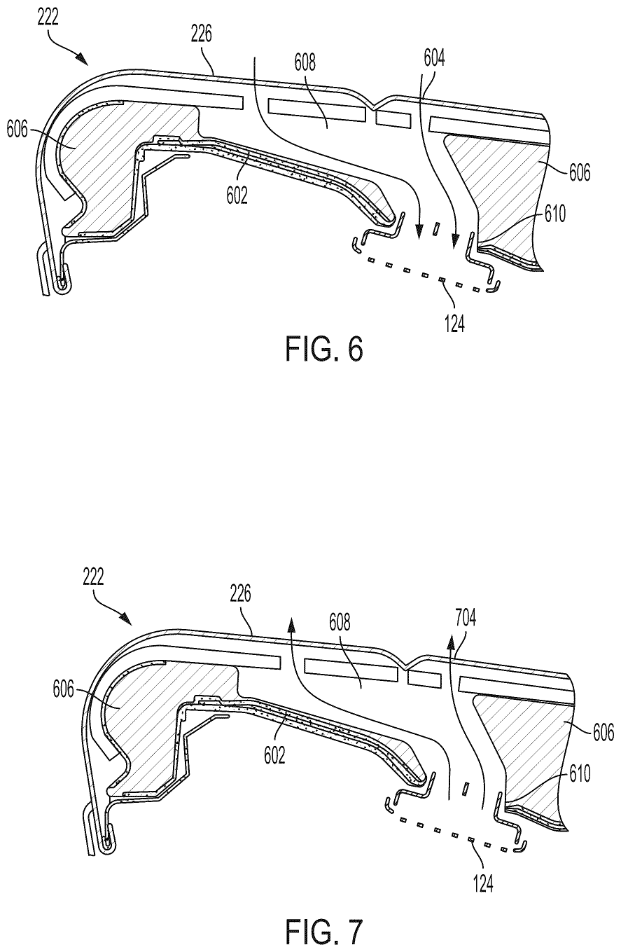

FIGS. 6 and 7 are each a sectional side view of a portion of the lower seat half 222 of the seat cooling system 100 of FIGS. 2 and 3, respectively. With combined reference to FIGS. 1-7, the seat 120 may further include a base 602 below the lower seating surface 226 and/or the upper seating surface 228. The base 602 may be rigid and form a supporting structure of the seat 120. Foam 606 may be positioned between the base 602 and the lower seating surface 226 and/or the upper seating surface 228. The foam 606 may provide support and/or cushioning for the occupant.

The seat 120 may further include one or more channels (or passageways) 608 between the seating surfaces 226, 228 and the base 602 for guiding air to and/or from the seating surfaces 226, 228 and/or through the seat 120. The one or more channels 608 may be defined by passageways formed and/or cut into the foam 606. In examples, the one or more channels 608 may guide air between one or more openings 610 in the base 602 and the lower seating surface 226 and/or the upper seating surface 228 such that air can flow in an inward flow direction 604, meaning from the seating surfaces 226, 228, through the one or more channels 608, and out of the one or more openings 610 in the base 602 (as shown in FIG. 6) and/or in an outward flow direction 704, meaning from the one or more openings 610, through the one or more channels 608, and out of the seating surfaces 226, 228 (as shown in FIG. 7).

The seat cooling system 100 may further include a fan 124 coupled to the base 602 and/or positioned within the seat 120. In examples, the seat cooling system 100 may include a plurality of fans, the plurality of fans including at least one fan positioned within the lower seat half 222 and at least one other fan positioned within the upper seat half 224. In examples, the fan 124 may be positioned within and/or over the one or more openings 610 in the base 602. The fan 124 may be a centrifugal fan and may have two blower directions (i.e., the inward flow direction 604 and the outward flow direction 704). In some examples, the fan 124 may be a centrifugal seat ventilation fan. The fan 124 may be configured to blow air with equal force in the two blower directions, however, in some examples the fan 124 may be configured to blow air with unequal force in the two blower directions. The fan 124 may move (or blow) air and/or conditioned air in the inward flow direction 604 to cool the seat 120 and/or the seating surfaces 226, 228 and/or in the outward flow direction 704 to cool the seat 120, the seating surfaces 226, 228, and/or the occupant.

When moving the air in the inward flow direction 604 (as shown in FIGS. 2 and 6), the fan 124 may pull at least a portion of air that is above the seating surfaces 226, 228 through the seating surfaces 226, 228, through the one or more channels 608, and out through the one or more openings 610 and/or the fan 124. The air that is above the seating surfaces 226, 228 may be conditioned air from the HVAC device 130 exiting from the one or more front air vents 136a (as shown in FIG. 2). In examples, when exiting the one or more openings 610 and/or the fan 124, the air may exit into the cabin 202. In other examples, when exiting the one or more openings 610 and/or the fan 124, the air may enter an inlet/outlet 402 of the seat air duct 138c to exit outside of the cabin 202 and/or to circulate back into the HVAC device 130. The inlet/outlet 402 of the seat air duct 138c may be in close proximity (e.g., within 10 inches, 5 inches, 3 inches, 1 inch, and/or less than 1 inch) to the fan 124. In some examples, the inlet/outlet 402 of the seat air duct 138c may be coupled to the floor 204, the seat 120, the lower seat half 222, and/or the base 602.

When moving the air in the outward flow direction 704 (as shown in FIGS. 3 and 7), the fan 124 may pull and/or push at least a portion of air that is below and/or behind the seat 120 and push the air through the one or more openings 610, the fan 124, the one or more channels 608, and/or the seating surfaces 226, 228. The air that is below and/or behind the seat 120 may be conditioned air exiting from the one or more rear air vents 136b (as shown in FIG. 3) and/or from the inlet/outlet 402 of the seat air duct 138c.

When the cabin 202 and/or the seat 120 of the vehicle 102 is hot (e.g., when the vehicle 102 was outside in the sun on a summer day), the inward flow direction 604 is preferred to cool the seat 120. This is because conditioned air exiting the one or more front air vents 136a may be pulled through the seat 120 and/or the seating surfaces 226, 228 to cool the seat 120 and/or the seating surfaces 226, 228 (as shown in FIG. 2). When the cabin 202 and/or the seat 120 of the vehicle 102 is hot, the outward flow direction 704 is not preferred to cool the seat 120 because conditioned air from the HVAC device 130 directed to the one or more rear air vents 136b and/or the seat air duct 138c may heat up while traveling in the rear air duct 138b and/or the seat air duct 138c before exiting the one or more rear air vents 136b. The rear air duct 138b leading from the HVAC device 130 to the one or more rear air vents 136b is generally longer than the front air duct 138a leading from the HVAC device 130 to the one or more front air vents 136a and thus the conditioned air is more likely to heat up when traveling from the HVAC device 130 to the one or more rear air vents 136b than to the one or more front air vents 136a. In addition, if conditioned air is pushed through a hot seat 120 and/or hot seating surfaces 226, 228, then the conditioned air may heat up and thus hot air would be blown onto the occupant of the seat 120 leading to an inefficient seat 120 cooling method and occupant discomfort. Once the rear air duct 138b, the seat air duct 138c, the cabin 202 and/or the seat 120 have sufficiently cooled, the outward flow direction 704 is preferred because conditioned air may be pushed through the seat 120 and/or the seating surfaces 226, 228 to cool the seat 120, the seating surfaces 226, 228, and/or the occupant of the seat 120. In examples, while the occupant is being cooled by the fan 124 moving conditioned air in the outward flow direction 704, the one or more front air vents 136a may direct conditioned air toward the occupant such that the occupant is cooled from the front and the back (as shown in FIG. 3).

A required duration of time for the fan 124 to operate in the inward flow direction 604 to cool the seat 120 before the outward flow direction 704 becomes preferable may be based on a starting temperature of the seat 120 and/or the cabin 202. The required duration of time may be further based on a thermal mass of the seat 120, occupant preferences, and/or ambient weather information.

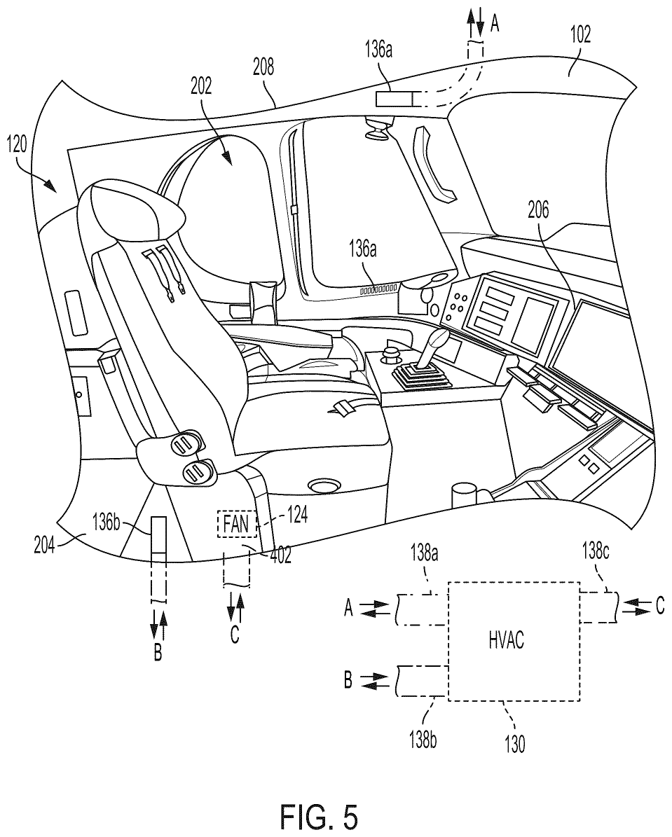

Turning briefly to FIG. 5, FIG. 5 is a schematic side view of the cabin 202 of the vehicle 102 including the example seat cooling system 100 of FIG. 1. With combined reference to FIGS. 1-5, in FIG. 5, the vehicle 102 is a plane, with the HVAC device 130 being adapted for the plane. The HVAC device 130 may be located under the floor 204, within the ceiling 208, and/or within the dashboard (or instrument panel) 206 of the vehicle 102. As shown by FIG. 5, the one or more front air vents 136a may be located on the ceiling 208 and/or on the instrument panel 206 of the vehicle 102. In examples, the one or more front air vents 136a may be adjacent to the instrument panel 206.

Turning again to FIG. 1, the seat cooling system 100 may further include one or more sensors 116. The one or more sensors 116 may include a seat temperature sensor 116a, a cabin temperature sensor 116b, a duct temperature sensor 116c, an ambient temperature sensor 116d, and/or an occupant sensor 116e.

The seat temperature sensor 116a may be coupled to the seat 120, the lower seat half 222, the upper seat half 224, the seating surfaces 226, 228, and/or the base 602. In examples, the seat cooling system 100 may include a plurality of seat temperature sensors. The seat temperature sensor 116a may measure, detect, and/or determine a temperature of the seat 120, the lower seat half 222, the upper seat half 224, the seating surfaces 226, 228, and/or the occupant.

The cabin (or internal) temperature sensor 116b may be coupled to the dashboard 206, the ceiling 208, and/or the seat 120. In examples, the seat cooling system 100 may include a plurality of cabin temperature sensors. The cabin temperature sensor 116b may measure, detect, and/or determine a temperature of the seat 120, the cabin 202, and/or the air within the cabin 202.

The duct temperature sensor 116c may be coupled to the HVAC device 130, the one or more front air vents 136a, the one or more rear air vents 136b, and/or the one or more air ducts 138. In examples, the seat cooling system 100 may include a plurality of duct temperature sensors. The duct temperature sensor 116c may measure, detect, and/or determine a temperature of the air within the one or more air ducts 138 and/or a temperature of the air exiting the one or more front air vents 136a and/or the one or more rear air vents 136b.

The ambient temperature sensor 116d may be coupled to a front bumper of the vehicle 102. In examples, the seat cooling system 100 may include a plurality of ambient temperature sensors. The ambient temperature sensor 116d may measure, detect, and/or determine a temperature of the air outside the cabin 202 and/or the vehicle 102.

The occupant sensor 116e may be coupled to the dashboard 206, the ceiling 208, the seat 120, the lower seat half 222 and/or the upper seat half 224. The occupant sensor 116e may detect and/or determine whether an occupant is seated on the seat 120. In examples, when the seat cooling system 100 includes a plurality of seats the seat cooling system 100 may include a plurality of occupant sensors. The occupant sensor 116e may increase the efficiency of the seat cooling system 100 by enabling the seat cooling system 100 to cool one or more occupied seats of the plurality of seats and not unoccupied seats. The occupant sensor 116e may be a pressure sensor, a camera, a thermal camera, a radar sensor, a lidar sensor, and/or a seat belt sensor.

The seat cooling system 100 may further include one or more processors, such as an electronic control unit (ECU) 106. The ECU 106 may be implemented as a single ECU or in multiple ECUs. The ECU 106 may be electrically connected to some or all of the components of the vehicle 102 and/or the seat cooling system 100. The ECU 106 may be electrically connected to the one or more sensors 116, the seat 120, the fan 124, the HVAC device 130, the one or more air vents 136, the one or more air ducts 138, a memory 108, a network access device 114, a user interface 110, and/or a navigation unit 118. The ECU 106 may include one or more processors (or controllers) specifically designed for controlling operations of the vehicle 102, such as controlling the HVAC device 130 and cooling the cabin 202 and/or the seat 120.

The seat cooling system 100 may further include the memory 108. The memory 108 may be electrically connected to the ECU 106. In examples, the memory 108 may be communicatively coupled (e.g., via network 140) to the ECU 106 such that the memory 108 is remote from the ECU 106 and/or the vehicle 102. In other examples, the memory 108 may be electrically connected to the ECU 106 and a remote memory (e.g., database 146) may be communicatively coupled to the ECU 106, with the remote memory having similar, additional, and/or different functions as the memory 108 (e.g., greater storage capacity, enabling over-the-air updates, etc.). The memory 108 may store instructions to execute on the ECU 106 and may include one or more of a random access memory (RAM) or other volatile or non-volatile memory. The memory 108 may be a non-transitory memory or a data storage device, such as a hard disk drive, a solid-state disk drive, a hybrid disk drive, or other appropriate data storage, and may further store machine-readable instructions, which may be loaded and executed by the ECU 106. The memory 108 may store vehicle parameters (e.g., vehicle weight, transmission gear information, etc.).

The memory 108 may further store an ambient temperature threshold, a cabin temperature threshold, a first seat temperature threshold, a second seat temperature threshold, and/or a duct temperature threshold. The memory 108 may further store one or more predetermined durations of time and/or an occupant selected duration of time. The one or more predetermined durations of time may be the required durations of time for the fan 124 to operate in the inward flow direction 604 to cool the seat 120 to a predetermined temperature at one or more starting temperatures of the seat 120. At least one of the one or more predetermined durations of time and/or the occupant selected duration of time may be based on the thermal mass of the seat 120 and/or a starting temperature of the seat 120, the seating surfaces 226, 228, and/or the occupant. Generally, a higher thermal mass and/or starting temperature of the seat 120 corresponds to higher predetermined durations of time.

The seat cooling system 100 may further include the network access device 114. The network access device 114 may be electrically connected to the ECU 106 and may include a communication port or channel, such as one or more of a Wi-Fi unit, a Bluetooth® unit, a Radio Frequency Identification (RFID) tag or reader, a DSRC unit, and/or a cellular network unit for accessing a network 140 (e.g., 3G, 4G, 5G, etc.). The network access device 114 may transmit data to and receive data from devices and systems not directly connected to the vehicle 102. For example, the ECU 106 may communicate with a user device 142 (e.g., a mobile device, phone, tablet, laptop, etc.) through the network access device 114. In examples, a user (e.g., the owner of the vehicle 102) may use the user device 142 to communicate with the ECU 106 to start the vehicle 102 and/or the seat cooling system 100. This allows the user to manually precondition the seat 120 before entering the vehicle 102. In examples, the ECU 106 may receive current and/or future weather information for a region where the vehicle 102 is currently located through the network access device 114. The current and/or future weather information may include the ambient air temperature and/or the humidity. The ECU 106 may use the current and/or future weather information to precondition the seat 120. Preconditioning may occur during vehicle 102 charging and/or when the vehicle 102 is parked during normal operation. Preconditioning the seat 120 may include directing conditioned air to the one or more front air vents 136a and pulling, by the fan 124, the conditioned air through the seat 120 in the inward flow direction 604 to cool the seat 120. Preconditioning the seat 120 may result in increased occupant comfort and more efficient occupant cooling which can improve fuel economy and/or electric range. In examples, the network access device 114 may enable the ECU 106 to communicate with one or more remote servers 144 and/or one or more databases 146. The one or more databases 146 may receive vehicle usage history data from the ECU 106 and may store the vehicle usage history data, the vehicle usage history data including how and/or when an occupant activates and/or deactivates the seat cooling system 100. The one or more remote servers 144 may have predictive capabilities by using machine learning systems trained with the vehicle usage history data such that the one or more remote servers 144 are able to predict when the occupant would likely want the seat cooling system 100 to be activated and/or deactivated, and/or when the occupant would likely want the seat cooling system 100 to precondition the seat 120 based on ambient weather data and/or vehicle temperature data. The one or more remote servers 144 may receive the ambient weather data and/or the vehicle temperature data from the ECU 106. The ECU 106 may receive the predictions from the one or more remote servers 144 and control the seat cooling system 100 based on the received predictions.

The seat cooling system 100 may further include the navigation unit 118. The navigation unit 118 may be electrically connected to the ECU 106 and may provide vehicle information (or data) and/or navigational map information to the ECU 106. The navigation unit 118 may have and/or be connected to a Global Positioning System (GPS) device. The vehicle information may include the current position, location, current time at the current position, direction of travel, and/or speed of the vehicle 102. In examples, the ECU 106 may determine whether to start conditioning the seat 120 based on the received vehicle information and/or the current weather information. For example, if the vehicle 102 is located in an area and during a time of day that the ambient air temperature and/or humidity is high, the ECU 106 may start conditioning the seat 120.

The seat cooling system 100 may further include the user interface 110. The user interface 110 may provide an interface to the occupant of the vehicle 102 to interact with and/or receive output from the ECU 106. The user interface 110 may have a user interface element, such as a touch-screen with a button, knob, graphical user interface (GUI) and/or other input/output device coupled to the ECU 106 to provide input and/or output from the ECU 106, such as to display a notification and/or provide an indicator. The user interface 110 may enable the occupant to activate the seat cooling system 100 to condition the seat 120 and/or to deactivate the seat cooling system 100. In examples, the user interface 110 may enable the occupant to schedule one or more times when the seat cooling system 100 will start preconditioning the seat 120.

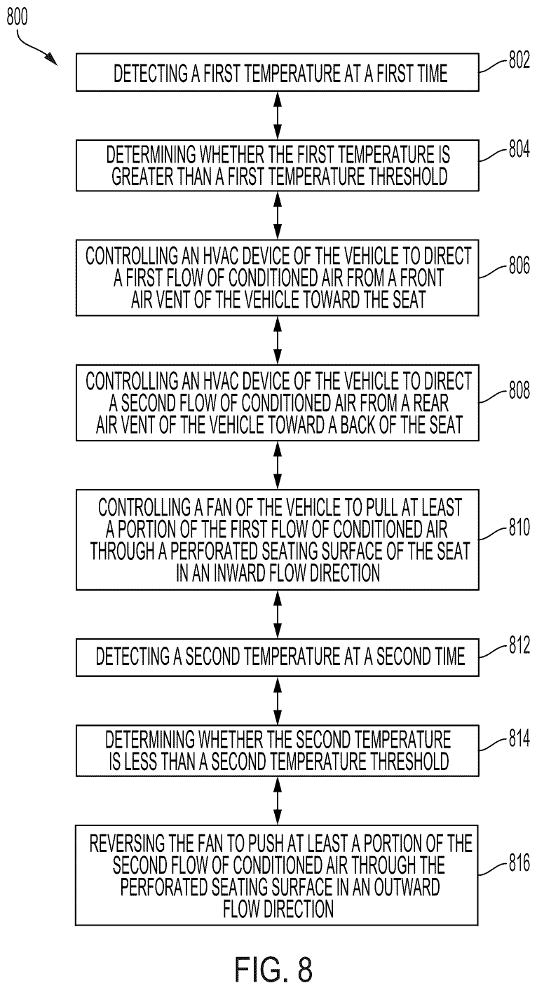

FIG. 8 is a flow diagram of an example process 800 for cooling a seat of a vehicle. One or more computers or one or more data processing apparatuses, for example, the ECU 106 of the seat cooling system 100 of FIG. 1, appropriately programmed, may implement the process 800. For ease of description, the process 800 is described below with reference to FIGS. 1-7. The process 800 of the present disclosure, however, is not limited to use of the exemplary seat cooling systems of FIGS. 1-7.

The seat cooling system 100 may detect a first temperature at a first time (802). The first temperature may be a temperature of the seat 120, the seating surfaces 226, 228, the cabin 202, the occupant, and/or the air outside the vehicle 102. The first temperature may be detected, measured, and/or determined by the seat temperature sensor 116a, the cabin temperature sensor 116b, the duct temperature sensor 116c, and/or the ambient temperature sensor 116d. In examples, detecting the first temperature may be performed in response to the ECU 106 detecting a user input. The ECU 106 may detect the user input when a user remotely starts the vehicle 102 through a key fob of the vehicle 102 and/or through the user device 142. In examples, the user input may be from a user interacting with the user interface 110 of the vehicle 102.

In another example, detecting the first temperature may be performed in response to the occupant sensor 116e detecting an occupant sitting in the seat 120. In examples, when the seat cooling system 100 includes a plurality of seats, the seat cooling system 100 may only condition the seat 120 if an occupant is detected in the respective seat to prevent wasting energy on conditioning an unoccupied seat. In addition, the seat cooling system 100 may direct conditioned air only to an occupied seat thereby increasing the amount of conditioned air blown onto the occupant and saving energy.

In another example, the seat cooling system 100 and/or the ECU 106 may learn an occupant's behavior and detecting the first temperature may be performed based on the learned behavior. The ECU 106 may learn an average time when an occupant starts the vehicle 102 and may detect the first temperature at and/or before the learned average time to begin the process (i.e., detecting the first temperature) of preconditioning the vehicle 102 such that the seat 120 will be cool when the occupant enters the vehicle 102. The ECU 106 may also learn at what average ambient temperatures the occupant manually activates the seat cooling system 100 to condition the seat 120 and may begin the process of preconditioning the vehicle 102 at the learned average ambient temperatures automatically. The ECU 106, using the navigation unit 118, may also learn common locations, and the average time at the respective common location, when the occupant starts the vehicle 102 and may detect the first temperature at and/or before the learned average time at the respective common location.

The seat cooling system 100 may determine whether the first temperature is greater than a first temperature threshold (804). The ECU 106 may determine whether the first temperature is greater than the first temperature threshold. As previously discussed, the first temperature threshold may be stored in the memory 108 and/or may be selected by the occupant.

In response to determining the first temperature is greater than the first temperature threshold, the seat cooling system 100 may control the HVAC device 130 of the vehicle 102 to direct a first flow of conditioned air to the one or more front air vents 136a of the vehicle 102 and toward the seat 120 (806). The first flow of conditioned air may be directed to a front side 250 of the seat 120.

The ECU 106 may turn on (or activate) the HVAC device 130 and/or control the HVAC device 130 to direct the first flow of conditioned air to the one or more front air vents 136a based on: a temperature of the air outside the vehicle 102 being greater than the ambient temperature threshold; a temperature of the cabin 202 and/or the air in the cabin 202 being greater than the cabin temperature threshold; a temperature of the seat 120, the seating surfaces 226, 228, and/or the occupant being greater than the seat temperature threshold; and/or a temperature of the air within (or exiting) the one or more air ducts 138 being greater than the duct temperature threshold.

The seat cooling system 100 may control the HVAC device 130 of the vehicle 102 to direct a second flow of conditioned air to the one or more rear air vents 136b of the vehicle 102 and toward the seat 120 (808). In examples, the second flow of conditioned air may be directed to the one or more rear air vents 136b and toward the back 240 and/or bottom of the seat 120. As discussed above, when directing conditioned air to the one or more rear air vents 136b, the conditioned air may travel within the rear air duct 138b and/or the seat air duct 138c. Because the rear air duct 138b and/or the seat air duct 138c may be longer than the front air duct 138a, the thermal mass and high thermal energy of a hot vehicle 102 and/or the one or more air ducts 138 may cause the conditioned air to be hotter when exiting the rear air duct 138b and/or the seat air duct 138c than when exiting the front air duct 138a since the conditioned air would be traveling for a longer time. Thus, it is advantageous to initially direct conditioned air to both the one or more front air vents 136a and the one or more rear air vents 136b, even when initially only the conditioned air from the one or more front air vents 136a will be pulled through the seat 120, to begin the process of cooling the rear air duct 138b and/or the seat air duct 138c. In examples, the rear air duct 138b and/or the one or more rear air vents 136b may be closed by the ECU 106 while the fan 124 blows in the inward flow direction 604 to conserve energy, and may be opened by the ECU 106 to allow conditioned air to exit the one or more rear air vents 136b when the fan 124 is controlled and/or reversed and blowing in the outward flow direction 704.

The seat cooling system 100 may control the fan 124 of the vehicle 102 to pull at least a portion of the first flow of conditioned air through a perforated seating surface of the seat 120 in the inward flow direction 604 (810). As discussed above, it is more efficient to pull the first flow of conditioned air coming from the one or more front air vents 136a because, at least initially, it will be cooler than the second flow of conditioned air coming from the one or more rear air vents 136b, and because the seat 120 must be cooled before conditioned air is pushed through the seat 120 to avoid pushing hot air onto the occupant.

The seat cooling system 100 may detect a second temperature at a second time (812). The second temperature may be a temperature of: the seat 120; the seating surfaces 226, 228; the cabin 202; the occupant; the air within and/or exiting the rear air duct 138b, the seat air duct 138c, the one or more rear air vents 136b; and/or the air outside of the vehicle 102. The second temperature may be detected, measured, and/or determined by the seat temperature sensor 116a, the cabin temperature sensor 116b, the duct temperature sensor 116c, and/or the ambient temperature sensor 116d.

The seat cooling system 100 may determine whether the second temperature is less than a second temperature threshold (814). The ECU 106 may determine whether the second temperature is less than the second temperature threshold. As previously discussed, the second temperature threshold may be stored in the memory 108 and/or may be selected by the occupant and may be based on the thermal mass of the seat 120. Determining whether the second temperature is less than the second temperature threshold ensures that the seat 120 has sufficiently cooled before the seat cooling system 100 begins pushing conditioned air through the seat 120. In examples, the seat cooling system 100 and/or the ECU 106 may continuously monitor the temperature of the seat 120 and determine whether the temperature of the seat 120 is less than the second temperature threshold.

In response to the seat cooling system 100 determining the second temperature is less than the second temperature threshold, the seat cooling system 100 may control and/or reverse the fan 124 to push at least a portion of the second flow of conditioned air through the perforated seating surface in an outward flow direction 704 (816). Once the seat 120 has sufficiently cooled, the seat cooling system 100 will control and/or reverse a blower direction of the fan 124 such that the fan 124 will push conditioned air through the seat 120 instead of pulling conditioned air though the seat 120. In examples, the seat cooling system 100 may continue to direct conditioned air to the one or more front air vents 136a in order to cool the occupant from two directions. In examples, the seat cooling system 100 may control and/or reverse the fan 124 in response to a predetermined amount of time from the first time expiring instead of detecting the second temperature at the second time and determining whether the second temperature is less than the second temperature threshold.

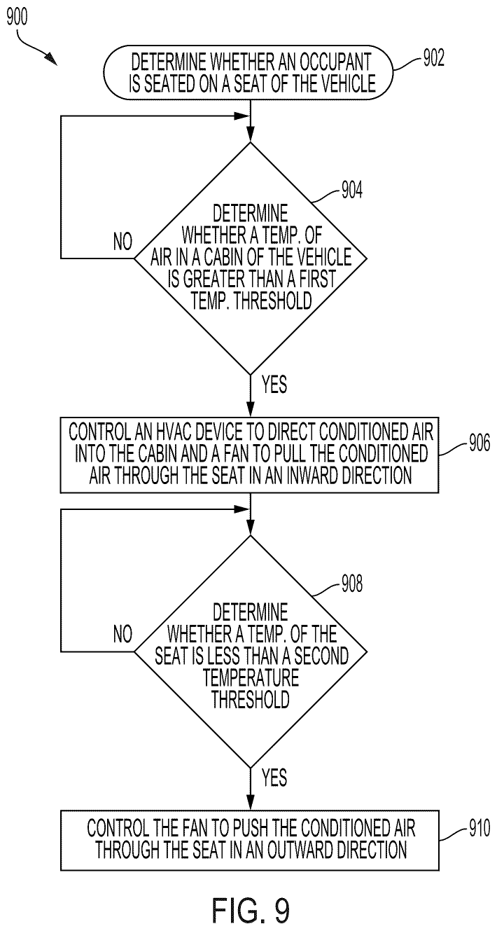

FIG. 9 is a flow diagram of an example process 900 for cooling a seat of a vehicle. One or more computers or one or more data processing apparatuses, for example, the ECU 106 of the seat cooling system 100 of FIG. 1, appropriately programmed, may implement the process 900. For ease of description, the process 900 is described below with reference to FIGS. 1-7. The process 900 of the present disclosure, however, is not limited to use of the exemplary seat cooling systems of FIGS. 1-7.

The seat cooling system 100 may detect, by the occupant sensor 116e, whether an occupant is seated on the seat 120 of the vehicle 102 (902). Detecting the occupant in the seat 120 ensures that energy is not wasted by conditioning an empty seat 120.

The seat cooling system 100 may determine whether a temperature of air in the cabin 202 of the vehicle 102 is greater than a first temperature threshold (904). The cabin temperature sensor 116b may detect the temperature of the air in the cabin 202. The ECU 106 may determine whether the temperature of the air in the cabin 202 is greater than the first temperature threshold by receiving a cabin temperature reading from the cabin temperature sensor 116b and comparing the cabin temperature reading to the first temperature threshold. If the answer at block 904 is no, the seat cooling system 100 will continually monitor the temperature of the air in the cabin 202 and determine if the temperature of the air in the cabin 202 is greater than the first temperature threshold. In examples, if the answer at block 904 is no, the seat cooling system 100 may perform other functions (e.g., monitoring for a user input to activate the seat cooling system 100 manually). If the answer at block 904 is yes, the seat cooling system 100 may proceed to block 906.

The seat cooling system 100 may start the HVAC device 130 to direct conditioned air into the cabin 202 and the fan 124 to pull the conditioned air through the seat 120 in an inward direction 604 (906). The ECU 106 may control and/or start the HVAC device 130 to direct conditioned air into the cabin 202 and the fan 124 to pull the conditioned air through the seat 120 in an inward direction 604 (906).

The seat cooling system 100 may determine whether a temperature (or current temperature) of the seat 120 is less than a second temperature threshold (908). The seat 120 temperature sensor 116a may detect the temperature of the seat 120. The ECU 106 may determine whether the temperature of the seat 120 is less than the second temperature threshold by receiving a seat temperature reading from the seat temperature sensor 116a and comparing the seat temperature reading to the second temperature threshold. If the answer at block 908 is no, the seat cooling system 100 will continually monitor the temperature of the seat 120 and determine if the temperature of the seat 120 is less than the second temperature threshold. If the answer at block 908 is yes, the seat cooling system 100 may proceed to block 910.

The seat cooling system 100 may open the rear air duct 138b and/or the one or more rear air vents 136b to allow conditioned air to flow through the rear air duct 138b and/or the one or more rear air vents 136b and control and/or reverse the blower direction of the fan 124 to push the conditioned air through the seat 120 in the outward direction 704 (910). The ECU 106 may control and/or open the rear air duct 138b and/or the one or more rear air vents 136b to allow conditioned air to flow through the rear air duct 138b and/or the one or more rear air vents 136b. The conditioned air may flow to the occupant through dedicated ducting. The dedicated ducting may be the seat air duct 138c and/or the one or more channels 608. The seat cooling system 100 may further save energy by waiting until the blower direction of the fan 124 is controlled and/or reversed to open the rear air duct 138b and/or the one or more rear air vents 136b such that the conditioned air is directed through the one or more front air vents 136a before the conditioned air is directed through the one or more rear air vents 136b. This ensures that energy is expensed directing conditioned air to behind and/or below the seat 120 when the conditioned air will be pushed from behind and/or below the seat 120 and through the seat 120.

Exemplary embodiments of the invention have been disclosed in an illustrative style. Accordingly, the terminology employed throughout should be read in a non-limiting manner. Although minor modifications to the teachings herein will occur to those well versed in the art, it shall be understood that what is intended to be circumscribed within the scope of the patent warranted hereon are all such embodiments that reasonably fall within the scope of the advancement to the art hereby contributed, and that that scope shall not be restricted, except in light of the appended claims and their equivalents.

What is claimed is:

1. A seat cooling system for a vehicle, comprising:
an HVAC device configured to direct conditioned air into a cabin of the vehicle;
a seat coupled to a floor of the vehicle and having:
a seating surface that is perforated such that air can flow through the seating surface, and
a base below the seating surface;
a fan coupled to the base and configured to pull air through the seating surface in an inward flow direction and to push air through the seating surface in an outward flow direction;
a temperature sensor configured to detect an internal temperature of the vehicle; and
an electronic control unit (ECU) electrically connected to the HVAC device, the fan, and the temperature sensor and configured to:
control the HVAC device to direct a first flow of conditioned air and a second flow of conditioned air into the cabin,
control the fan to pull at least a portion of the first flow of conditioned air through the seating surface in the inward flow direction, and
control the fan to push at least a portion of the second flow of conditioned air through the seating surface in the outward flow direction when the internal temperature of the vehicle is less than a first temperature threshold.

2. The seat cooling system of claim 1, wherein:
the ECU is further configured to receive a user input from a mobile device in communication with the ECU, and
the controlling the HVAC device and/or the controlling the fan to pull at least the portion of the first flow of conditioned air is performed based on the user input.

3. The seat cooling system of claim 1, further comprising a user interface coupled to the dashboard of the vehicle and configured to receive a user input, wherein the controlling the HVAC device and/or the controlling the fan to pull at least the portion of the first flow of conditioned air is performed based on the user input.

4. The seat cooling system of claim 1, wherein:
the temperature sensor is coupled to the seat, and
the internal temperature of the vehicle is a temperature of the seat.

5. The seat cooling system of claim 1, further comprising:
a user interface coupled to the dashboard of the vehicle and configured to receive a user input, wherein:
the controlling the fan to pull at least the portion of the first flow of conditioned air is performed when the internal temperature of the vehicle is greater than a second temperature threshold; and
the user input includes the first temperature threshold and/or the second temperature threshold.

6. The seat cooling system of claim 1, further comprising one or more front air vents coupled to a dashboard and/or a ceiling of the vehicle, wherein the first flow of conditioned air is directed into the cabin through the one or more front air vents and toward the seat.

7. The seat cooling system of claim 6, further comprising one or more rear air vents coupled to the floor of the vehicle and/or the base of the seat, wherein the second flow of conditioned air is directed into the cabin through the one or more rear air vents and toward a bottom and/or a back of the seat.

8. The seat cooling system of claim 7, further comprising:
a front air duct configured to carry conditioned air from the HVAC device to the one or more front air vents, and
a rear air duct configured to carry conditioned air from the HVAC device to the one or more rear air vents.

9. A seat cooling system for a vehicle, comprising:
an HVAC device configured to direct conditioned air into a cabin of the vehicle;
a seat coupled to a floor of the vehicle and having:
a seating surface that is perforated such that air can flow through the seating surface, and
a base below the seating surface;
a fan coupled to the base and configured to pull air through the seating surface in an inward flow direction and to push air through the seating surface in an outward flow direction;
a temperature sensor configured to detect an internal temperature of the vehicle; and
an electronic control unit (ECU) electrically connected to the HVAC device, the fan, and the temperature sensor and configured to:
control the HVAC device to direct a first flow of conditioned air through a front air vent of the vehicle and toward the seat and a second flow of conditioned air through a rear air vent of the vehicle and toward a bottom of the seat,
control the fan to pull at least a portion of the first flow of conditioned air through the seating surface in the inward flow direction when the internal temperature of the vehicle is greater than a first temperature threshold, and
control the fan to push at least a portion of the second flow of conditioned air through the seating surface in the outward flow direction when the internal temperature of the vehicle is less than a second temperature threshold.

10. The seat cooling system of claim 9, further comprising an occupant sensor configured to detect an occupant sitting in the seat, wherein the controlling the HVAC device is performed in response to the occupant sensor detecting the occupant sitting in the seat.

11. The seat cooling system of claim 9, wherein the first temperature threshold and/or the second temperature threshold are selected by an occupant through a user interface of the vehicle.

12. The seat cooling system of claim 9, wherein the fan is positioned at least partially within a lower half of the seat.

13. The seat cooling system of claim 9, further comprising one or more air ducts configured to carry the first flow of conditioned air from the HVAC device to the front air vent and the second flow of conditioned air from the HVAC device to the rear air vent.

14. The seat cooling system of claim 9, wherein the front air vent is positioned forward and/or above the seat and the rear air vent is positioned rearward and/or below the seat.

15. The seat cooling system of claim 9, wherein the first flow of conditioned air is directed through the front air vent before the second flow of conditioned air is directed through the rear air vent.

16. A seat cooling system for a vehicle, comprising:
an HVAC device configured to direct conditioned air into a cabin of the vehicle;
a plurality of seats coupled to a floor of the vehicle and each having:
a seating surface that is perforated such that air can flow through the seating surface, and
a base below the seating surface;
one or more fans coupled to the base of each seat of the plurality of seats and configured to pull air through the seating surface of each seat of the plurality of seats in an inward flow direction and to push air through the seating surface of each seat of the plurality of seats in an outward flow direction;
one or more temperature sensors configured to detect an internal temperature of the vehicle; and
an electronic control unit (ECU) electrically connected to the HVAC device, the one or more fans, and the one or more temperature sensors and configured to:
control the HVAC device to direct one or more first flows of conditioned air through one or more front air vents of the vehicle and toward a quantity of seats of the plurality of seats and one or more second flows of conditioned air through one or more rear air vents of the vehicle and toward a bottom of the quantity of seats, control the one or more fans to pull at least a portion of the one or more first flows of conditioned air through the seating surface of each of the quantity of seats in the inward flow direction when the internal temperature of the vehicle is greater than a first temperature threshold, and
control the one or more fans to push at least a portion of the one or more second flows of conditioned air through the seating surface of each of the quantity of seats in the outward flow direction when the internal temperature of the vehicle is less than a second temperature threshold.

17. The seat cooling system of claim 16, wherein at least one of the one or more front air vents is positioned forward of each of the plurality of seats.

18. The seat cooling system of claim 17, wherein at least one of the one or more rear air vents is positioned rearward and/or below each of the plurality of seats.

19. The seat cooling system of claim 16, further comprising one or more occupant sensors coupled to each of the plurality of seats and configured to detect whether an occupant is sitting in a respective seat of the plurality of seats, wherein the quantity of seats is equal to the number of detected sitting occupants.

20. The seat cooling system of claim 16, wherein:
the one or more temperature sensors are coupled to each of the plurality of seats, and
the internal temperature of the vehicle is a temperature of the plurality of seats.
